SEQUENCE LISTING (14 sequences)

SEQ ID NO: 1 - DNA, 47 bp, Artificial Sequence
  DNA ligand
gatcgagggcagcgatagctgggctaataaggttagccccatcggtc

SEQ ID NO: 2 - DNA, 70 bp, Artificial Sequence
  DNA ligand
caattgatcgagggcagcgatagctgggctaataaggttagccccatcggtcagatagtatgttcatcag

SEQ ID NO: 3 - DNA, 66 bp, Artificial Sequence
  DNA ligand
caatttcgagggcagcgatagctgggctaataaggttagccccatcggagatagtatgttcatcag

SEQ ID NO: 4 - DNA, 64 bp, Artificial Sequence
  DNA ligand
caattcgagggcagcgatagctgggctaataaggttagccccatcgagatagtatgttcatcag

SEQ ID NO: 5 - DNA, 15 bp, artificial sequence
  Primer
gagggcagcgatagc

SEQ ID NO: 6 - DNA, 21 bp, Artificial Sequence
  Primer
gtgctgatgaacatactatct

SEQ ID NO: 7 - DNA, 17 bp, Artificial Sequence
  DNA ligand
ctgccctcgatcaattg

SEQ ID NO: 8 - DNA, 15 bp, Artificial Sequence
  DNA ligand
ctgccctcgaaattg

SEQ ID NO: 9 - DNA, 14 bp, Artificial Sequence
  DNA ligand
ctgccctcgaattg

SEQ ID NO: 10 - DNA, 79 bp, Artificial Sequence
  DNA ligand
gtaccagcttattcaatttcgagggcagcgatagctgnnnnnnnnnnnnnnnnnccatcggagatagtatgttcatcag

SEQ ID NO: 11 - DNA, 79 bp, Artificial Sequence
  DNA ligand
gtaccagcttattcaatttcgagggnnnnnnnnnnnnnnnnnnnnnnnnnnnnnccatcggagatagtatgttcatcag

SEQ ID NO: 12 - DNA, 79 bp, Artificial Sequence
  DNA ligand
gtaccagcttattcaatttcgagggcagcgatagctgggctaataaggttagccccatcggagatagtatgttcatcag

SEQ ID NO: 13 - DNA, 19 bp, Artificial Sequence
  DNA ligand
gtaccagcttattcaattt

SEQ ID NO: 14 - DNA, 19 bp, Artificial Sequence
  DNA ligand
ctgatgaacatactatctc

(19) United States
(12) Patent Application Publication
(10) Pub. No.: US 2012/0289411 A1
(43) Pub. Date: Nov. 15, 2012

(54) METHOD FOR SCREENING NUCLEIC ACID LIGAND

(75) Inventors: Satoru Hatakeyama, Tama-shi (JP); Takahisa Ibii, Sanda-shi (JP)

(73) Assignee: CANON KABUSHIKI KAISHA, Tokyo (JP)

(21) Appl. No.: 13/511,641

(22) PCT Filed: Feb. 23, 2011
(86) PCT No.: PCT/JP2011/001024

§ 371 Date: May 23, 2012

(30) Foreign Application Priority Data
Feb. 26, 2010 (JP) 2010-043559
Jan. 31, 2011 (JP) 2011-018651

(51) Int. Cl. C40B 30/04; C40B 20/00

(52) U.S. Cl. 506/2; 506/9

(57) ABSTRACT

Provided is a method for screening a library of candidate for a nucleic acid ligand. The method includes the steps of: (a) preparing a library of candidate of nucleic acid ligands; (b) contacting, under the absence of a target substance, the library with a supporting member binding to at least one of conserved sequence domains included in the ligand, and then separating and removing a ligand which does not form an intermolecular duplex; and (c) dissociating the intermolecular duplex by contacting, under the presence of the target substance, the target substance with the remaining ligand forming the intermolecular duplex obtained in step (b), and then separating and collecting a ligand having a specific secondary structure formed by the binding to the target substance, wherein the method includes at least one time of step (b) and at least one time of step (c).

### TECHNICAL FIELD

The present invention relates to methods for screening for a nucleic acid ligand, and in particular, to a method for screening for a nucleic acid ligand which has an affinity for a target substance and which forms a particular secondary structure upon binding to a target substance.

### BACKGROUND ART

An aptamer refers to a nucleic acid ligand which specifically binds to a target substance. In 1990, Gold et al. are first to propose its basic concept. Known is a method for selecting and obtaining an aptamer by using what is called a SELEX method utilizing the binding affinity for a target substance as an index. A phrase “the Systematic Evolution of Ligands by EXponential enrichment” is abbreviated as “SELEX”.

Until now, a wide variety of molecules have been disclosed as a target substance for an aptamer. Examples of the reported target substance include, for example, various proteins, enzymes, peptides, antibodies, receptors, hormones, amino acids, antibiotics, and other various compounds.

SELEX methods utilizing the binding affinity for a target substance as an index have often been improved in the affinity and specificity for the target substance so as to achieve various particular objects. In addition, for a method utilizing a structural change upon binding to a target substance as an index, U.S. patent application Ser. No. 07/960,093 discloses that a nucleic acid (e.g., a bent DNA) having a particular structural property is selected by using a combination of SELEX and gel electrophoresis. Further, there has been known an in vitro selection using an aptamer in a structure-switching signaling aptamer so as to aim at obtaining an aptamer for a sensor utilizing a structural change upon binding to a target substance.

As a sensor which utilizes a nucleic acid ligand undergoing a structural change upon binding to a target substance, a method using, for example, a fluorescent reporter is found to be particularly useful. In respect to the above method using a fluorescent reporter, various methods have been developed. Examples of the reported methods include a aptamer based monochromophore reporter approach, an aptamerbeacon (aptamer based bichromophore reporter approach), an antitode (DNA/DNA duplex-to-DNA/target complex structure-switching approach, QDNA), an in situ labeling approach, a chimeric aptamer approach, and a fluorescent dyeing approach. The structural change of a nucleic acid ligand upon binding to a target substance provides an important function affecting an SNR (signal-to-noise ratio) or limit of detection of a sensor. Strongly desired is development of a technic for precisely regulating a structural change and a simple, systematic and robust technique for obtaining a ligand in which binding to a target substance causes a structural change.

### CITATION LIST

### Patent Literature

PTL 1: U.S. patent application Ser. No. 07/960,093

### Non Patent Literature

NPL 1: Nucleic Acids Research, 2000, vol. 28, No. 9, 1963-1968

### SUMMARY OF INVENTION

Generally, a method for obtaining a nucleic acid ligand, represented by a SELEX method, is to select a nucleic acid ligand having a higher affinity for a target substance from a library of candidate ligand of nucleic acids by utilizing a binding affinity for the target substance as an index.

The above method disclosed in U.S. patent application Ser. No. 07/960,093 provides a selection utilizing a physical property change resulting from a structural change upon binding to a target substance. This method can efficiently obtain a nucleic acid ligand undergoing a structural change as a whole nucleic acid ligand-target substance complex molecular. However, it cannot be specified which part of the nucleic acid sequence undergoes a structural change upon binding to the target substance and/or which part forms a secondary structure. The method does not utilize, as an index for a structural change, duplex formation between certain specific predesigned nucleic acid sequences upon binding to a target substance.

In an in vitro selection of an aptamer for a structure-switching signaling aptamer, a sensor used in a DNA/DNA duplex-to-DNA/target complex structure-switching approach (aptamer based bichromophore reporter approach) is developed, the sensor obtained by selecting an aptamer capable of undergoing a structural change by utilizing, as an index, both the binding affinity for a target substance and the capacity for structural change upon binding to a target substance. This method beforehand engineers a plurality of domains as a conserved sequence domain of a library of candidate ligand of nucleic acids. However, each conserved sequence domain does not provide a complementary sequence and does not have a function to form an intramolecular duplex between the conserved sequence domains. Besides, the conserved sequence domains include a plurality of primer binding domains (PBDs) and central-fixed sequence motifs.

This aptamer sensor used in a DNA/DNA duplex-to-DNA/target complex structure-switching approach is a method for obtaining a labeled aptamer molecule having the capacity for structural change while keeping the affinity for a target substance, compared with a robust and systematic (rational) method using a common sequence. Specifically, two kinds of labeled-oligoDNAs (FDNA, QDNA) are complementary to the central-fixed sequence motif and one of the conserved primer binding domains, respectively, to form a duplex. Next, a distance between the FDNA and the QDNA changes upon a structural change resulting from the binding to a target substance or the distance changes upon dissociation of the FDNA, and the target substance is then detected. However, this method does not regulate a structural change (duplex formation) after the binding to a target substance. In addition, it is predicted that the degree of the above structural change does not remain constant, and also predicted to be difficult to regulate the dissociation of the FDNA by the binding to a target substance. Consequently, the distance between the FDNA and QDNA may not be precisely regulated.

In respect to a method for obtaining a nucleic acid ligand (a molecular beacon aptamer) sequence used for a sensor that utilizes a structural change in the nucleic acid ligand, commonly used is a method including obtaining a sequence by a SELEX method and then imparting capacity for structural change by reengineering the sequence. For example, there has been a report on a molecular beacon aptamer having an ability of undergoing a structural change (duplex formation) upon binding to the target substance. Such a method may not confer the affinity for the target substance since the sequence is reengineered following obtaining the nucleic acid ligand to impart the capacity for structural change to the sequence. Alternatively, there is a concern that the necessity of reengineering depending on the respective sequence is brought about. Thus, current situation tells that the above method cannot be said to be a robust method because optimal engineering is required to be repeated for each nucleic acid ligand obtained.

In addition, there is a sensing method which regulates a structural change by adding a sequence, as an antidote, complementary to the nucleic acid ligand sequence obtained by a SELEX method. However, the affinity for a target substance may change, and the optimal engineering (e.g., a sequence, a length of the sequence, an insertion of mismatch, a position of the sequence) is also required for an individual ligand.

That is, there exists no method for screening a library of candidate of nucleic acid ligands for a nucleic acid ligand by utilizing, as an index, both the binding affinity for a target substance and the capacity for structural change which forms an intramolecular duplex among a plurality of complementary sequences which have been designed as conserved sequence domains, of a library of candidate of nucleic acid ligands upon binding to the target substance.

As a result of intensive studies to solve the problems with the above-mentioned conventional techniques, the present inventors have found out a method for screening for a nucleic acid ligand by utilizing, as an index, both the binding affinity for a target substance and the capacity for structural change. A method for screening for a nucleic acid ligand of the present invention is a method for screening a library of candidate of nucleic acid ligands for a nucleic acid ligand which forms a specific secondary structure upon binding to a target substance. The method includes the steps of: (a) preparing a library of candidate of nucleic acid ligands including a random sequence domain to bind a target substance and a conserved sequence domain to form a specific secondary structure; (b) contacting, under the absence of the target substance, the library of candidate ligand with a supporting member in which a complementary sequence domain complementarily binding to at least one of the conserved sequence domains included in the nucleic acid ligand is disposed on a surface of the supporting member, and then separating and removing a nucleic acid ligand which does not form an intermolecular duplex by utilizing a phenomenon that the intermolecular duplex is formed between a nucleic acid ligand and the complementary sequence domain on the surface of the supporting member; and (c) dissociating the intermolecular duplex by contacting, under the presence of the target substance, the target substance with the remaining nucleic acid ligand forming the intermolecular duplex obtained in step (b), and then separating and collecting a nucleic acid ligand having a specific secondary structure formed by the binding to the target substance, wherein the method includes at least one time of step (b) and at least one time of step (c).

In addition, another method for screening for a nucleic acid ligand of the present invention is a method for screening a library of candidate of nucleic acid ligands for a nucleic acid ligand which forms a specific secondary structure upon binding to a target substance. The method includes the steps of: (a′) preparing a library of candidate of nucleic acid ligands including a random sequence domain to bind a target substance and a conserved sequence domain to form a specific secondary structure; (b′) contacting, under the presence of the target substance, the library of candidate ligand with a supporting member in which a complementary sequence domain complementarily binding to at least one of the conserved sequence domains included in the nucleic acid ligand is disposed on a surface of the supporting member, and then separating and collecting a nucleic acid ligand which does not form an intermolecular duplex by utilizing a phenomenon that the intermolecular duplex is formed between a nucleic acid ligand and the complementary sequence domain on the surface of the supporting member; and (c′) removing the target substance from the nucleic acid ligand separated and collected in step (b′); and (d′) contacting, under the absence of the target substance, the supporting member with a nucleic acid ligand obtained in step (c′) from which the target substance is removed, and then separating and collecting a nucleic acid ligand forming the intermolecular duplex between the nucleic acid ligand and the complementary sequence domain on the surface of the supporting member.

### ADVANTAGEOUS EFFECTS OF INVENTION

The present invention can provide a novel method for efficiently and systematically screening for a nucleic acid ligand which has an affinity for a target substance and which forms a specific intramolecular duplex among a plurality of predesigned sequences complementary to one another in conserved sequence domains upon binding to the above target substance. The conserved sequence domains forming the intramolecular duplex can be used in the case of screening by using another target substance in a similar manner, so that a variety of sensor devices can be manufactured systematically and readily.

In addition, a nucleic acid ligand obtained according to a method of the present invention can contribute to applications for various fields (e.g., various biosensors, molecular switches, diagnostic agents) which utilize a structural change of a nucleic acid ligand upon binding reaction with a target substance. In particular, the above ligand is effective as a labeled aptamer in which a reporter molecule (e.g., a fluorescent molecule) is engineered to be introduced into a region forming the intramolecular duplex. For example, in an aptamer sensor in an aptamer based bichromophore reporter approach, the distance between the two types of labeled molecule can be precisely regulated after the binding to the target substance. Further, examples of the features of the labeled aptamer include more stability as a complex with the target substance by forming the intramolecular duplex upon binding to the target substance.

Further features of the present invention will become apparent from the following description of the exemplary embodiments with reference to the attached drawings.

### BRIEF DESCRIPTION OF DRAWINGS

FIG. 1 is a schematic diagram illustrating regions of a nucleic acid sequence prepared as a library of candidate of nucleic acid ligands.

FIG. 2A is a schematic diagram illustrating a separation step of the present invention.

FIG. 2B is a schematic diagram illustrating a separation step of the present invention.

FIG. 2C is a schematic diagram illustrating a separation step of the present invention.

FIG. 3A is a diagram illustrating results of an analysis of predicted secondary structures of nucleic acid sequences.

FIG. 3B is a diagram illustrating results of an analysis of predicted secondary structures of nucleic acid sequences.

FIG. 3C is a diagram illustrating results of an analysis of predicted secondary structures of nucleic acid sequences.

FIG. 3D is a diagram illustrating results of an analysis of predicted secondary structures of nucleic acid sequences.

FIG. 3E is a diagram illustrating results of an analysis of predicted secondary structures of nucleic acid sequences.

FIG. 3F is a diagram illustrating results of an analysis of predicted secondary structures of nucleic acid sequences.

FIG. 4 is a graph illustrating results showing an abundance ratio of nucleic acid amplification products after a separation step.

### DESCRIPTION OF EMBODIMENTS

Hereinafter, embodiments of the present invention are illustrated using Figures, Tables, Formulae and Examples. In addition, of note is that these Figures, Tables, Formulae, Examples and descriptions are for the illustration, and do not limit the scope of the present invention. It is needless to mention that additional embodiments are within the scope of the present invention, as long as they are in agreement with the purport of the present invention.

### First Embodiment

A method for screening for a nucleic acid ligand according to a first embodiment of the present invention is a method for screening a library of candidate of nucleic acid ligands for a nucleic acid ligand which forms a specific secondary structure upon binding to a target substance, the method including the following steps (a) to (c).

Specifically, the method includes the steps of: (a) preparing a library of candidate of nucleic acid ligands including a random sequence domain to bind a target substance and a conserved sequence domain to form a specific secondary structure; (b) contacting, under the absence of the target substance, the library of candidate ligand with a supporting member in which a complementary sequence domain complementarily binding to at least one of the conserved sequence domains included in the nucleic acid ligand is disposed on a surface of the supporting member, and then separating and removing a nucleic acid ligand which does not form an intermolecular duplex by utilizing a phenomenon that the intermolecular duplex is formed between a nucleic acid ligand and the complementary sequence domain on the surface of the supporting member as a result of the contacting; and (c) dissociating the intermolecular duplex by contacting, under the presence of the target substance, the target substance with the remaining nucleic acid ligand which forms the intermolecular duplex and which is obtained in step (b), and then separating and collecting a nucleic acid ligand having the specific secondary structure formed by the binding to the target substance, wherein the method includes at least one time of step (b) and at least one time of step (c).

Alternatively, step (c) includes: collecting a remaining nucleic acid ligand forming the intermolecular duplex obtained in step (b), mixing the nucleic acid ligand with the target substance, and contacting the mixture with the supporting member, and then separating and collecting a nucleic acid ligand having a specific secondary structure formed upon binding to the target substance by utilizing a phenomenon that the intermolecular duplex is not formed.

Besides, a separation step including step (b) and step (c) in the present invention can repeat multiple times, and the number of times is not limited. For example, as long as the ratio of the number of molecules of the targeted nucleic acid sequence population to the number of molecules of the untargeted nucleic acid ligand population is retained or the ratio of the number of molecules capable of identifying the targeted nucleic acid ligand is retained so that the screening is achieved, the number of times is not limited.

The numbering of the Drawings is described. Reference numeral 1 denotes a (forward) primer sequence for PCR. Reference numeral 2 denotes a stem-forming region (complementary to reference numeral 4). Reference numeral 3 denotes a random sequence domain. Reference numeral 4 denotes a stem-forming region (complementary to reference numeral 2). Reference numeral 5 denotes a (reverse) primer sequence for PCR. Reference numeral 6 denotes a substrate. Reference numeral 7 denotes streptavidin. Reference numeral 8 denotes biotin. Reference numeral 9 denotes a sequence region including a stem-forming region. Reference numeral 10 denotes a target substance.

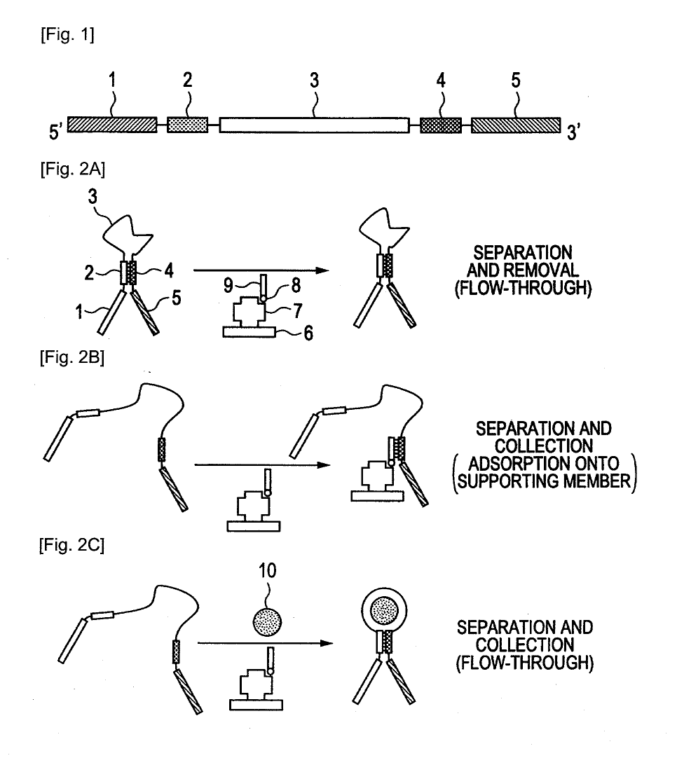

As illustrated in FIGS. 1 and 2A, 2B and 2C, a nucleic acid ligand according to a present embodiment includes the random sequence domain 3 to bind the target substance 10, conserved sequence domains 2 and 4 to form a specific secondary structure. Besides, the specific secondary structure according to the present invention can only be formed when a nucleic acid ligand binds to a given target substance.

In addition, a sequence region complementarily binding to at least one of the conserved sequence domains is disposed on the surface of the support 9. The supporting member is made to contact a library of candidate of nucleic acid ligands including a targeted nucleic acid ligand of the present invention which has a plurality of preconserved sequence regions (conserved sequence domains) complementary to one another in the library of candidate of nucleic acid ligands. In this embodiment, a nucleic acid ligand having an intended function can be screened by utilizing the difference between the ability of forming an intramolecular complementary duplex among the conserved sequence domains in the library of candidate ligand and the ability of forming an intermolecular complementary duplex with a complementary sequence domain disposed on a supporting member.

Since a complementary duplex is more readily formed intramolecularly than intermolecularly, the intramolecular complementary duplex is readily formed among the conserved sequence domains when the library of candidate ligand is made to contact the supporting member under the absence of the target substance (i.e., the equilibrium is biased). Specifically, a possibility of the formation of the intramolecular duplex is high when compared with the formation of the intermolecular duplex with the complementary sequence domain disposed on the surface of the supporting member. By using this phenomenon, a nucleic acid ligand (an untargeted nucleic acid ligand) having an intramolecular duplex among the conserved sequence domains can be separated and removed (FIG. 2A).

A targeted nucleic acid ligand of the present invention is a nucleic acid forming an intermolecular duplex with the complementary sequence domain disposed on the surface of the supporting member (FIG. 2B). The targeted nucleic acid ligand is separated from the surface of the supporting member by contacting the targeted nucleic acid ligand with a target substance under the presence of the target substance and binding each other (FIG. 2C). Accordingly, the targeted nucleic acid ligand of the present invention which binds the target substance can be screened. In addition, only the nucleic acid ligand capable of forming a specific secondary structure according to the present invention binds the target substance. Thus, only the targeted nucleic acid ligand of the present invention that has formed the intermolecular duplex binding to the complementary sequence domain disposed on the surface of the supporting member is separated from the supporting member.

Besides, the phrase “under the presence of a target substance” herein means the presence in a condition having a free target substance or in a condition having a target substance being bound to the supporting member. In contrast, the phrase “under the absence of a target substance” means neither the presence in a condition having a free target substance nor in a condition having a target substance being bound to the supporting member.

### Second Embodiment

In contrast, carrying out the same procedure under the presence of a target substance enables a nucleic acid ligand forming an intramolecular duplex structure among conserved sequence domains upon binding of a targeted nucleic acid ligand to the target substance to be separated, enriched and collected. Accordingly, a method for screening for a nucleic acid ligand according to a second embodiment of the present invention is a method for screening a library of candidate of nucleic acid ligands for a nucleic acid ligand which forms a specific secondary structure upon binding to a target substance, the method including the following steps (a′) to (d′).

Specifically, the method includes the steps of: (a′) preparing a library of candidate of nucleic acid ligands including a random sequence domain to bind a target substance and a conserved sequence domain to form a specific secondary structure; (b′) contacting, under the presence of the target substance, the library of candidate ligand with a supporting member in which a complementary sequence domain complementarily binding to at least one of the conserved sequence domains included in the nucleic acid ligand is disposed on a surface of the supporting member, and then separating and collecting a nucleic acid ligand which does not form an intermolecular duplex by utilizing a phenomenon that the intermolecular duplex is formed between a nucleic acid ligand and the complementary sequence domain on the surface of the supporting member; (c′) removing the target substance from the nucleic acid ligand separated and collected in step (b′); and (d′) contacting, under the absence of the target substance, the supporting member with a nucleic acid ligand obtained in step (c′) from which the target substance is removed, and then separating and collecting a nucleic acid ligand forming the intermolecular duplex between the nucleic acid ligand and the complementary sequence domain on the surface of the supporting member.

### Third to Fifth Embodiments

A third embodiment of the present invention provides a screening which combines a conventional SELEX method. Specifically, the embodiment further includes, before step (b) or (b′), the steps of: contacting the library of candidate ligand with the target substance so that a nucleic acid ligand having a higher affinity for the target substance forms a nucleic acid ligand-target substance complex; removing a nucleic acid ligand which does not form the complex; separating and collecting only a nucleic acid ligand having the higher affinity from the complex; and amplifying the nucleic acid ligand having the higher affinity to produce a library of candidate ligand of the enriched nucleic acid ligands.

Furthermore, the embodiment further includes, after step (d) or (d′), the steps of: contacting the target substance with a nucleic acid ligand forming a specific secondary structure from which the target substance is removed, the nucleic acid ligand obtained in step (d) or (d′) so that a nucleic acid ligand having a higher affinity for the target substance forms a nucleic acid ligand-target substance complex; removing a nucleic acid ligand which does not form the complex; separating and collecting only a nucleic acid ligand having the higher affinity from the complex; and amplifying the nucleic acid ligand to enrich the nucleic acid ligand having the higher affinity.

A fourth embodiment of the present invention provides a method for identifying a sequence of a nucleic acid ligand forming a specific secondary structure, the ligand obtained according to the above three embodiments of the method for screening. This embodiment is specifically described in the following Examples.

A fifth embodiment of the present invention provides a kit for screening a library of candidate of nucleic acid ligands for a nucleic acid ligand which forms a specific secondary structure upon binding to a target substance so as to carry out the above respective embodiments. The kit includes a library of candidate of nucleic acid ligands including a conserved sequence domain to form a specific secondary structure and a random sequence domain, and a supporting member of which a complementary sequence domain complementarily binding to at least one of the conserved sequence domains is disposed on the surface.

The followings are descriptions of a supporting member, etc., that is used in the present invention. Unless otherwise described, they can be applied to all the embodiments.

(Supporting Member/Immobilization)

As a material of the supporting member according to the present embodiments, materials of the supporting member used for DNA microarrays and nucleic acid purification can be employed. Examples of them include plastics, inorganic polymers, metals, metal oxides, natural polymers, composite materials thereof and the like. Specific examples of the plastics include polyethylene, polystyrene, polycarbonate, polypropylene, polyamide, phenol resin, epoxy resin, polycarbodiimide resin, polyimide and acrylic resins and the like. In addition, specific examples of the inorganic polymers include glass, quartz, carbon, silica gel, graphite and the like. Additionally, specific examples of the metals and metal oxides include gold, platinum, silver, copper, iron, aluminum, magnet, ferrite, alumina, silica, paramagnet, apatite and the like. Examples of the natural polymers include poly amino acid, cellulose, chitin, chitosan, alginate and derivatives thereof.

The shape of a supporting member according to the present embodiments is not particularly limited. A functional group to immobilize a nucleic acid may be introduced on the surface of a supporting member material, but it may not be introduced. In that case, the immobilization may be carried out directly by physical adsorption. A conventional known method for immobilizing nucleic acid (e.g., DNA) can be used for the surface of various supporting members in the present invention. There is a possibility that a random immobilization (e.g., physical adsorption utilizing hydrophobicity of nucleic acid, electrostatic adsorption utilizing negative charge derived from phosphates of the backbone) cannot retain an amount of immobilization due to a lower binding affinity for the supporting member per molecule. Accordingly, for the immobilization of a low-molecular-weight nucleic acid (an oligomer), chemical bonds may be used. In particular, the terminals of the nucleic acid may be immobilized thereon.

For example, for the case of the direct immobilization of nucleic acid onto gold, the nucleic acid whose terminal is thiolated can be used. When carboxylic acid groups are introduced on the surface of the supporting member, the dehydration and condensation with the nucleic acid whose terminal is aminated enable the immobilization to be carried out. Further, when streptavidin or avidin is immobilized on the surface of the supporting member, a nucleic acid whose terminal is biotinylated can be used. In order to facilitate a reaction of the library of candidate ligand of nucleic acids with a nucleic acid (conserved sequence) immobilized on the supporting member, a linker can be inserted between the supporting member and the conserved sequence. Insertion of the linker allows the steric hindrance of the molecule to be reduced during a solid-phase reaction of the supporting member. In addition, the length and kind of the linker can be appropriately selected depending on the reaction efficiency.

Further, so as to facilitate the reaction, the supporting member can be processed into microparticles. The microparticulation enables the surface area to be enlarged, which should have a promoting effect due to a lower reaction volume, a reaction under a high concentration condition and a pseudo-liquid-phase reaction while stirring. In addition, the microparticles can be used so as to simplify the separation step. Examples of the use include centrifugation of the microparticles, purification with the microparticle-packed column, separation and recovery using the magnet and the like. A conventional known technique can be employed as a technique to separate a free nucleic acid from a nucleic acid binding to a supporting member. In addition, a technique to purify a supporting member binding to a nucleic acid from a free target substance can also employ a conventional known technique in a similar manner.

(Nucleic Acid Ligand, Library of Candidate of Nucleic Acid Ligands, and Nucleic Acid)

The term “nucleic acid ligand” according to the present embodiments refers to artificial nucleic acid having a desired effect in chemical sensing. The nucleic acid ligand is often called an “aptamer”. The term “aptamer” is used herein as the term having the same meaning as the “nucleic acid ligand” unless otherwise described particularly. Examples of the desired effect include, but are not limited to, binding to a target substance, catalytically changing the target substance, inhibiting an effect of the target substance, promoting a reaction of the target substance with other molecules and the like. In an embodiment, these effects are exerted by an affinity specific to a target substance. Such a target substance is a compound other than a nucleic acid binding to a nucleic acid ligand mediated by a mechanism mainly depending on a Watson/Crick's base pair or a triplex binding. That is, those hybridizing one nucleic acid with another nucleic acid are not included in the present application.

The “library of candidate of nucleic acid ligands” (hereinafter, may be referred to as the “library of candidate ligand of nucleic acids”) according to the present embodiments is a mixture of nucleic acids having various sequences, the mixture including a desired aptamer. The library of candidate of nucleic acid ligands can be derived from naturally existing nucleic acid or portion thereof, chemically synthesized nucleic acid, enzymatically synthesized nucleic acid or nucleic acid produced by combinations of the above techniques. An aptamer included in a library of candidate of nucleic acid ligands according to the present embodiments has a versatile sequence (e.g., a random sequence domain) which exert the above desired effects, and a plurality of conserved sequence domains adjacent to the random sequence domain.

The number of the conserved sequence domains is at least two. Each domain has a sequence complementary to the other, which provides a prerequisite to form an intramolecular duplex of a nucleic acid. For the case of number of the domains being three or more, the ligand may have, but is not limited to, at least one pair of sequence domains complementary to one another as a combination. The “specific secondary structure” according to the present embodiments refers to at least an intramolecular duplex forming among the different complementary sequences in the conserved sequence domains. The structure includes those forming an intramolecular duplex including versatile sequences disposed adjacently. In addition, a tertiary structure derived from a duplex is not particularly limited. The sequence or nucleotides defining the above random sequence domain may be divided by the conserved sequence domain.

The number of nucleotides in the random sequence domain can be determined depending on the number of molecules in a library of the library of candidate of nucleic acid ligands and the volume, concentration and the like of an actual screening system. For example, the conserved sequence domains can be designed to be inserted at both sides of the random sequence domain, so that the random sequence domain is sandwiched therebetween. Such design can ensure a one-dimensional positioning in which the intramolecular conserved sequence domains are placed distally. Such a positioning enables the aptamer obtained by a screening undergoing a structural change upon interactions with a target substance, By the structural change the conserved sequence domains can be expected to form an intramolecular duplex and most approach one another.

The length of the conserved sequence domain (conserved sequence domain length) is not particularly limited, but may be a length that does not primarily form an intramolecular duplex among the conserved sequence domains in a condition without the presence of a target substance. For example, step (a) of the present invention is carried out, and the amount of the library of candidate of nucleic acid ligands collected after step (a) is estimated for the total amount of the library of candidate of nucleic acid ligands that is treated as an input. Then, the length of the conserved sequence domain providing a proper recovery rate for the screening can be appropriately determined. A perfectly complementary sequence is selected in particular, and the length of the conserved sequence domain is between 5 mer and 10 mer at room temperature under physiological conditions.

The length of the conserved sequence domain can be appropriately modified depending on a temperature, a salt concentration and pH of the screening and a Tm value of the sequence, etc. For example, software (e.g., mfold) for a secondary structure prediction of nucleic acid can predict in a certain degree whether or not a secondary structure is readily formed in the engineered conserved sequence domains in a certain particular nucleic acid ligand. In addition, the conserved sequences may not be perfectly complementary. For example, the conserved sequence may include a mismatch base pair such as G-G, G-T, G-A, A-A, A-C, C-C, C-T and T-T. In this case, the length of the conserved sequence is not limited.

The length of the conserved sequence domain does not represent the number of nucleotides that actually form a duplex under a condition having an interaction of a target substance with a nucleic acid ligand obtained according to the present invention. A structural analysis (e.g., NMR analysis) enables the number of nucleotides and the position forming a duplex among the conserved sequence domains to be analyzed in an aptamer during the actual binding to a target substance. If necessary, a final nucleic acid ligand can be yielded following the steps below. First, one or more nucleic acid ligands obtained according to the present invention are identified. Next, the structure of the aptamer at the time of binding to a target substance is analyzed. Then, an actual duplex-forming site proximal to a region including a region binding to the target substance and the engineered conserved sequence domain is determined. The conserved sequence domain may involve with desired effects represented by the binding to the target substance. However, a sequence region designed as a variety of sequences may be suitable from the viewpoint of a systematic screening for various target substances.

In addition, the “nucleic acid” according to the present embodiments means one of (single-stranded or double stranded) DNA and RNA, or chemically modified molecules thereof. Examples of the modification include, but are not limited to, the 3′ and 5′ modifications such as capping. The examples further include phosphorylation, amination, biotinylation, thiolation, fluorescent labeling and the like. The modification that is suitable for applications of an aptamer obtained in a method for screening of the present invention may be performed beforehand. In addition, the modification can be carried out partway along the sequence. In particular, examples of the modifications include those providing an additional chemical group by which a nucleotide of a nucleic acid ligand or a whole nucleic acid ligand incorporates additional charge, polarizability, hydrogen bonding, electrostatic interactions and fluidity. These modifications enable variations and binding capabilities of the affinity for a target substance to increase.

Examples of such modifications include, but are not limited to, sugar modifications at position 2′, pyrimidine modifications at position 5, purine modifications at position 8, modifications at exocyclic amines, 4-thiouridine substitutions and 5-bromo- or 5-iodo-uracil substitutions, or further include a backbone modification, methylation, a rare base-pair combination (e.g., a combination of isocytidine and isoguanidine that is an isomerized base) and the like. When an amplification step is carried out in the present invention, a method for modification that allows for the amplification can be selected.

(Reaction Condition)

Conditions for the step in a method for screening of the present invention are desirable to be set to conditions identical to conditions for actual use of an aptamer (e.g., solution conditions (e.g., a temperature, pH, a salt concentration, an additive)). In particular, it can be included that individual separation steps and a step of contacting a free target substance may be carried out under the same condition (e.g., solution conditions (e.g., a temperature, pH, a salt concentration)). In respect to the addition of non-specific adsorption inhibitors to a supporting member, conditions may differ from those of the actual use.

(Target Substance)

The target substance according to the present embodiments means a compound or molecule that is desired and is a subject of interest. The target substance can be a wide variety of molecules (e.g., biopolymers represented by proteins, low-molecular-weight compounds such as metabolites). Specific examples of the target substance can include, but are not particularly limited to, proteins, peptides, carbohydrates, sugars, glycoproteins, hormones, antibodies, metabolites, transition state analogs, cofactors, inhibitors, drugs, nutrients and the like. That is, as long as being able to bind a nucleic acid ligand and form an interaction with the ligand, the target substance does not have a particular limitation, and can be appropriately selected depending on its purpose.

(Combination with SELEX Method)

A nucleic acid sequence having a more affinity for a target substance can be obtained from a library of candidate of nucleic acid ligands by using a method further including the following steps in a method for screening for a nucleic acid ligand of the present invention. Specifically, the following steps (i) to (iv) are further included before steps (b) or (b′). Step (i) is a step of contacting the target substance with the library of candidate ligand so as to form a nucleic acid ligand-target substance complex by a nucleic acid ligand having a higher affinity for the target substance. Step (ii) is a step of removing a nucleic acid ligand that does not form the complex. Step (iii) is a step of separating and collecting only the nucleic acid ligand having the higher affinity from the complex. Step (iv) is a step of producing an enriched library of candidate of nucleic acid ligands by amplifying the nucleic acid ligand having the higher affinity.

The above step falls under what is called a SELEX method. A method of the present application can be combined with a conventional known SELEX method or an improved method thereof. A manner of the combination and an order of the steps in the combination are not particularly limited. As an embodiment, first, a SELEX method is carried out. Then, a library of candidate of nucleic acid ligands having a higher affinity is obtained. After that, an untargeted nucleic acid ligand of the present invention having an intramolecular duplex among conserved sequence domains is separated and removed under the absence of a target substance. Finally, a targeted nucleic acid of the present invention which forms an intramolecular duplex among the conserved sequence domains under the presence of the free target substance is separated and collected.

In addition, after step (d) or (d′) of the present invention, the following steps (I) to (IV) can be included. Step (I) is a step of contacting the target substance with a nucleic acid ligand forming a specific secondary structure from which the target substance is removed, the ligand obtained in step (d) or step (d′), so as to form a nucleic acid ligand-target substance complex by a nucleic acid ligand having a higher affinity for the target substance. Step (II) is a step of removing a nucleic acid ligand that does not form the complex. Step (III) is a step of separating and collecting only the nucleic acid ligand having the higher affinity from the complex. Step (IV) is a step of enriching the nucleic acid ligand having the higher affinity by amplification.

Such a combination is desirable for screening units from the viewpoint that a method having the fewer number of steps as possible reduces loss during collection or reduces a bias. The separation step may repeat the same number of times as that of the SELEX method, but the number is not particularly limited. For example, for a library of candidate ligand of nucleic acids obtained in the final round of a SELEX method, a targeted nucleic acid sequence can be obtained by repeating a separation step utilizing a difference in a duplex-forming ability once. In addition, the number of separation steps utilizing a difference in a duplex-forming ability can be each determined depending on its purpose. The number of separation steps may each differ.

When a SELEX method is combined, reaction conditions (e.g., a temperature, pH, a salt concentration) of the separation step utilizing the duplex-forming ability may be the same as those of a step in the SELEX method which makes a nucleic acid ligand-target substance complex form. Additives (e.g., non-specific adsorption inhibitors for a target substance or a library of candidate ligand of nucleic acids to a supporting member) can be appropriately changed because they depend on the types of supporting members and the functional groups on the surface thereof, the types of a target substance and the like. The principle of obtaining a nucleic acid sequence having a higher affinity for a target substance by a SELEX method can be used in the present application, and is not particularly limited.

Generally speaking, in a SELEX method, a step is performed which contacts a library of candidate ligand with a target substance so as to form a nucleic acid ligand-target substance complex by a nucleic acid sequence having a higher affinity for the target substance than the library of candidate ligand obtained in step (i). Next, the target substance is immobilized on a solid support, and is reacted with the library of candidate ligand of nucleic acids. Then, the process includes washing after the reaction and collecting a library of candidate ligand of nucleic acids forming a complex. By changing stringency during the reaction and washing in this process, a nucleic acid sequence having a higher affinity can be obtained. The stringency includes a temperature, pH of a buffer, a salt concentration, an additive during the reaction and washing and the like, and can be modified depending on its purpose.

The above solid support is defined as any surfaces that enable a target substance to be linked via covalent bonds or non-covalent bonds. Examples of the solid support include, but are not limited to, membranes, plastics, paramagnetic beads, charged papers, nylon, Langmuir-Blodgett films, functionalized glass, germanium, silicon, PTFE, polystyrene, gallium arsenide, gold and silver. Intended are any additional materials known to those skilled in the art, the materials including those capable of having a functional group (e.g., an amino group, a carboxyl group, a thiol group, a hydroxyl group) disposed on the surface. Examples of these surfaces include any topological surfaces, including, but are not limited to, a spherical surface, a grooved surface and a cylindrical surface. In contrast, it is possible to make a complex form by contacting a free target substance without using a solid support, followed by fractionation from the remaining library of candidate ligand of nucleic acids by utilizing the physical property resulting from the complex. For example, isothermo electrophoresis and chromatography can be available.

A step of amplification described herein can employ a conventional known method, and, for example, can be achieved by a PCR method. A library of candidate ligand of nucleic acids is amplified by a PCR method. Then, for example, from the duplex after the amplification by the PCR method using a biotinylated primer, an opposite strand (a complementary strand) of the nucleic acid ligand sequence in the duplex formed by the amplification can be separated and removed with a streptavidin column. A step of amplification and the following step of separation and purification are not limited to the above described method. When the step of amplification is carried out, the sequence of a library of candidate ligand of nucleic acids includes a versatile sequence domain (e.g., a random sequence domain) and a conserved sequence domain, as well as a primer sequence domain, which is a conserved sequence, for amplification. What is called a primer sequence domain for PCR amplification can be engineered at both the ends of a library of candidate ligand of nucleic acids.

The primer sequence domain is not particularly limited. However, a sequence that is not ready to form a secondary structure with the foregoing conserved sequence domain may be selected. This allows the PCR amplification to be performed efficiently. Software (e.g., mfold software) for predicting a secondary structure of nucleic acid can be used as a determination method. The primer sequence domain can be selected by setting a portion of versatile sequence domains as some model sequences, setting to a conserved sequence domain and a primer sequence domain for amplification, and examining the capacity for formation of the secondary structure between the conserved sequence domain and the primer sequence domain for amplification. In addition, the whole region of the conserved sequence domain or the portion thereof can be utilized as a portion of the primer sequence domain for amplification. An embodiment may include that the conserved sequence domains are disposed as a versatile sequence (a random sequence) is sandwiched therebetween, and the primer sequence domains for amplification are further disposed at both the ends of the conserved sequence domains (FIG. 1). An embodiment may further include that a portion of the conserved sequence domain is used as a primer sequence domain so as to reduce contribution to a nucleic acid ligand structure of the primer sequence domain for amplification. A nucleic acid sequence may be inserted between respective sequence domains as a linker portion.

(Aptamer Sensor and Additional Use)

A nucleic acid ligand obtained according to the present invention is considered to be a multifunctional drug or substance which performs drug delivery with high accuracy, the ligand identified as a nucleic acid ligand capable of specifically interacting with metabolites involving with, for example, a particular metabolic pathway, or with proteins. Further, it is deemed that identification of the aptamer capable of specifically interacting with a molecule which mimics a reaction intermediate enables a multistep reaction undergoing the unstable reaction intermediate to proceed efficiently. In addition, the nucleic acid ligand can be used as what is called a biosensor by adsorbing or attaching the ligand onto quartz crystal units, surface plasmon resonance substrates, electrodes or surface acoustic wave devices. In particular, examples of the use may include bio-sensors, molecular switches, signal transduction molecules and the like, which utilize a particular structural change upon binding to a target substance according to the present application.

### EXAMPLES

Although Examples of the present invention are described below in detail, the present invention is not limited to these Examples.

### Example 1

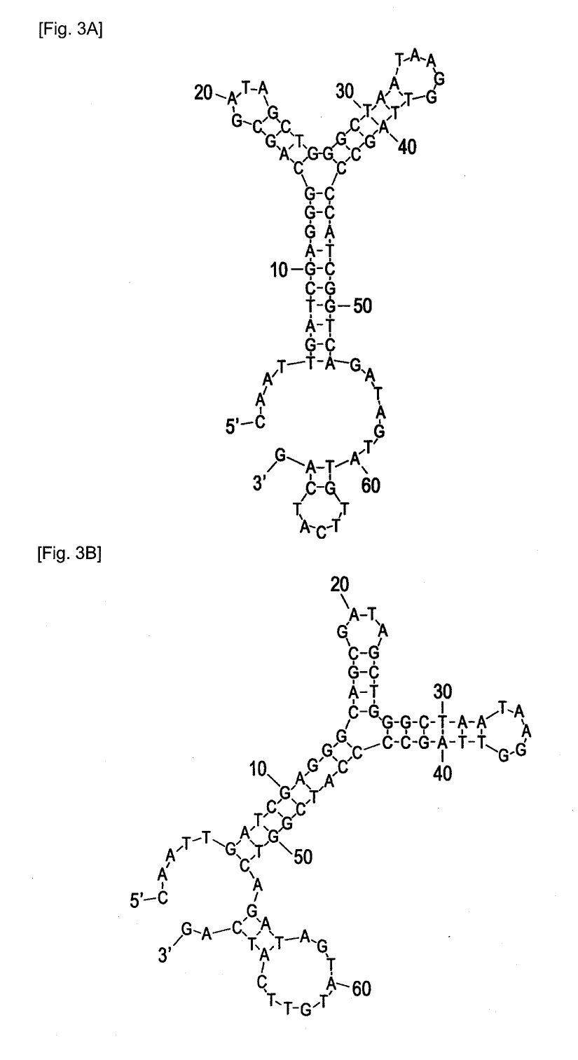

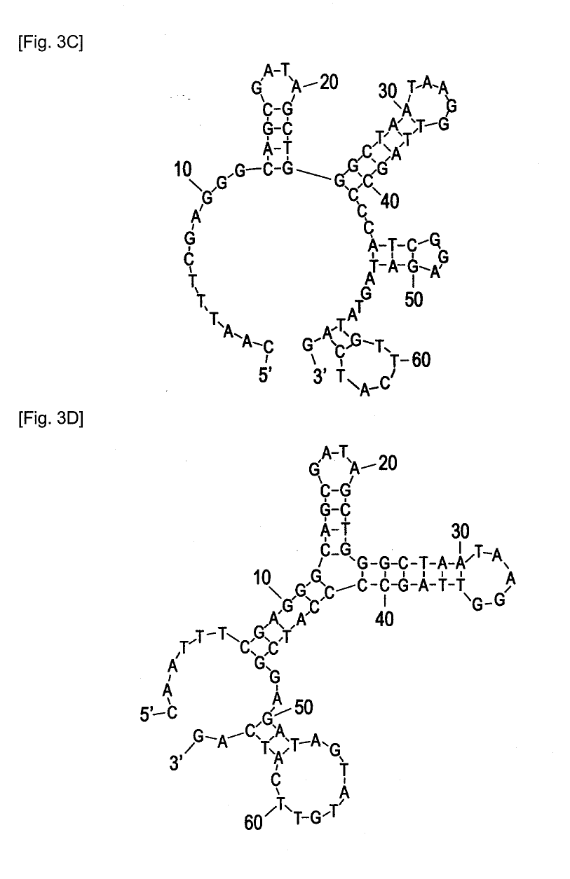

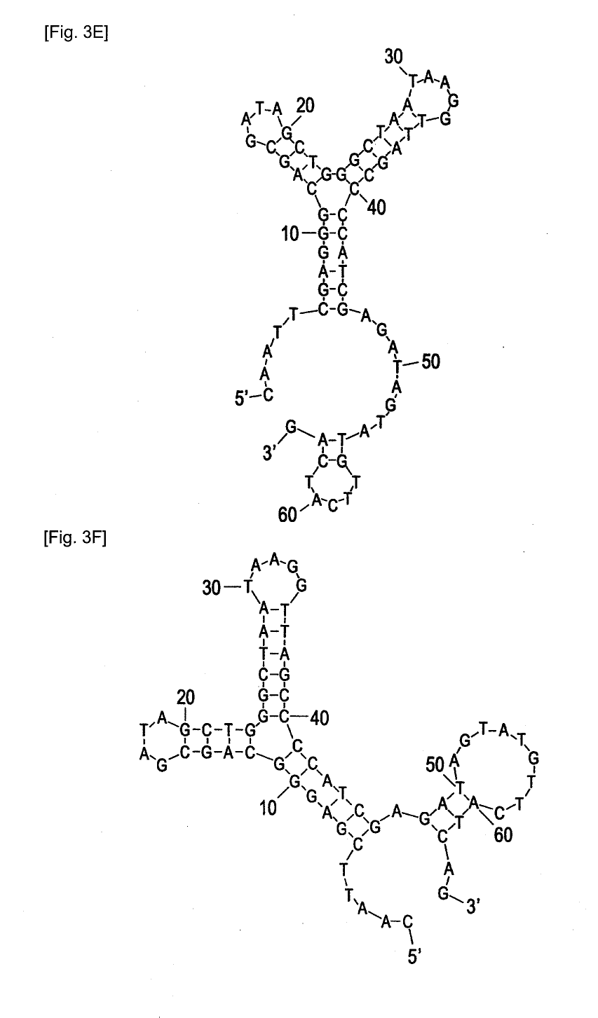

First, the following experiments were carried out so as to demonstrate a separation under the presence or absence of a target substance, the separation utilizing a secondary structure-forming ability of intramolecular stem regions as described in FIGS. 2A, 2B and 2C. Sequences were added to both the ends of the ch1-47 aptamer sequence (SEQ ID NO: 1), which is an aptamer sequence for a target substance (cholic acid), described in Nucleic Acids Research, 2000, vol. 28, No. 9, 1963-1968, to yield a standard aptamer sequence for cholic acid (SEQ ID NO: 2). The above SEQ ID NO: 2 was set to the standard aptamer sequence for cholic acid, and was subjected to a structural prediction by using software (mfold software) for predicting a nucleic acid secondary structure under the condition having 5 mM of Mg₂⁺ and 300 mM of Na⁺ at 20 degree. Two types of structures described in FIGS. 3A and 3B were predicted as a stable secondary structure of the standard aptamer for cholic acid. Both the structures included a triplex structure (i.e., 3-way junction) including a stem region, a first stem-loop region and a second stem-loop region as similar to those disclosed in the above previously reported publication. When the above previously reported publication is taken into consideration, the region binding to cholic acid is predicted to be a 3-way junction site.

SEQ ID NO 1:
5′-GATCGAGGGCAGCGATAGCTGGGCTAATAAGGTTAGCCCCATCGG
TC-3′
SEQ ID NO 2:
5′-CAATTGATCGAGGGCAGCGATAGCTGGGCTAATAAGGTTAGCCCC
ATCGGTCAGATAGTATGTTCATCAG-3′

The stem regions described in FIGS. 3A and 3B each have a region having 9 bp or 10 bp. In order to demonstrate a principle of the present invention, the length of the stem regions is appropriately shortened, thereby altering the stem-forming ability at a constant temperature. Then, the separation by a separation step of the present invention was carried out. Sequences in which 2 bp and 3 bp were each deleted from both the ends of a region 2 and a region 4 in FIG. 1, in the stem region (formed between the region 2 and region 4) were designed as stem deletion sets (SEQ ID NOs: 3 and 4). Two types of the structure (FIGS. 3C and 3D) were predicted as a stable secondary structure of the sequence having a 2-bp deletion. Also, two types of the structure (FIGS. 3E and 3F) were predicted as a stable secondary structure of the sequence having a 3-bp deletion. Next, secondary structures of respective sequences were predicted, and the length of base pairs of the stem formed between region 2 and region 4 in FIG. 1 was summarized in Table 1. Table 1 illustrated a relationship between the sequence of the deletion set and the predicted length of the stem region, so that a difference in the stem length and the stable structure was recognized. Then, the following experiments were carried out by using the standard aptamer sequence for cholic acid and deletion set sequence thereof.

SEQ ID NO 3:
5′-CAATTTCGAGGGCAGCGATAGCTGGGCTAATAAGGTTAGCCCCAT
CGGAGATAGTATGTTCATCAG-3′
SEQ ID NO 4:
5′-CAATTCGAGGGCAGCGATAGCTGGGCTAATAAGGTTAGCCCCATC
GAGATAGTATGTTCATCAG-3′

TABLE 1

| | Prediction by mFOLD | |
|---|---|---|
| | Length of a stem region | |
| | (Formed between a | |
| | region 2 and a region | |
| | 4 in FIG. 1) | ΔG value |
| 3-bp deletion | 6, 7 bp | −14.66, −14.87 kcal/mol |
| 2-bp deletion | 0, 6 bp | −15.22, −15.03 kcal/mol |
| Standard | 9, 10 bp | −16.14, −16.32 kcal/mol |
| sequence | | |

### Example 2

The sequences designed in Example 1 were synthesized as oligos in SIGMA Genosys Inc. PCR conditions were examined by using primer sequences for PCR (SEQ ID NOs: 5 and 6). The results showed that TAKARA LA Taq manufactured by TAKARA BIO Inc. was used as an enzyme (the reaction solution according to the protocol), and for the reaction condition, 25 times of the cycle of denaturation at 98 degree for 10 sec, annealing at 55 degree for 30 sec, and elongation at 72 degree for 15 sec were carried out. Finally, a cycle (at 72 degree for 1 min) was added to the condition. The above condition was set to a PCR condition to amplify each sequence to have an almost equivalent amount, and was used in the following.

SEQ ID NO 5:
5′-GAGGGCAGCGATAGC-3′
SEQ ID NO 6:
5′-GTGCTGATGAACATACTATCT-3′

### Example 3

It is demonstrated by utilizing an intramolecular secondary structure (duplex)-forming ability in the stem region as an index that the abundance ratio of various sequences changes. For this purpose, 5′-biotinylated oligo sequences (SEQ ID NOs: 7, 8 and 9) complementary to the stem region of each sequence (a standard aptamer sequence for cholic acid, sequences having a 2-bp or 3-bp deletion) were synthesized as oligos in SIGMA Genosys Inc. Each biotinylated oligoDNA having a final concentration of 50 mM was prepared in TTK buffer (100 mM Tris-HCl (pH 8.0), 0.1% Tween20, 1 M KCl). Streptavidin-immobilized beads (1 mg) manufactured by Bangs Laboratories, Inc. were washed twice with TTK buffer. Next, the buffer was discarded, and various biotinylated oligoDNAs having a concentration of 50 mM or 25 ml were added to different tubes. Then, the mixture was reacted at room temperature for 1 hour while stirring.

Absorbance of a supernatant after the reaction was determined with a spectrophotometer (at 260 nm), and it is verified that almost all the amount of the input DNA was immobilized. Then, the beads were collected with a magnet to discard the supernatant, and 50 ml of 0.15 N NaOH was added to remove non-specifically adsorbed DNA. The beads were washed well with TT buffer (250 mM Tris-HCl (pH 8.0), 0.1% Tween20). After that, the beads were suspended in TTE buffer (250 mM Tris-HCl (pH 8.0), 0.1% Tween20, 20 mM EDTA), and were incubated at 80 degree for 10 min to remove an unstable streptavidin. Finally, the beads were washed five times with a buffer for nucleic acid separation (50 mM Tris-HCl (pH 7.6), 300 mM NaCl, 30 mM KCl, 5 mM MgCl₂), and suspended in a fresh buffer for nucleic acid separation. The absorbance was measured with a spectrophotometer (at 427 nm), and a concentration of the respective beads on which the biotinylated DNA sequence was immobilized was estimated.

SEQ ID NO 7:
5′-CTGCCCTCGATCAATTG-3′
SEQ ID NO 8:
5′-CTGCCCTCGAAATTG-3′
SEQ ID NO 9:
5′-CTGCCCTCGAATTG-3′

### Example 4

First, 50 mg of respective biotinylated oligoDNA-immobilized beads as prepared in Example 3 were each weighed. Next, aptamer sequences corresponding to each of the DNA were prepared with a buffer for nucleic acid separation to have a final concentration of 100 nM and a volume of 50 ml. After denatured by treatment at 96 degree for 10 min, the mixture was cooled slowly at room temperature. Then, the mixture was mixed with 50 mg of the above immobilized beads, and was reacted for 1 hour with stirring in an incubator having a temperature of 20 degree. Immediately after the reaction, the beads and a supernatant were separated and collected by using a magnet. In terms of the beads, after washed twice with a buffer for nucleic acid separation, they were suspended in a fresh buffer for nucleic acid separation to react at 80 degree for 10 min. Finally, a supernatant was immediately separated and collected from the beads by using a magnet.

### Example 5

First, 50 mg of respective biotinylated oligoDNA-immobilized beads as prepared in Example 3 were each weighed. Next, aptamer sequences corresponding to each of the DNA were prepared with a 10 mM cholic acid-containing buffer for nucleic acid separation to have a final concentration of 100 nM and a volume of 50 ml. After denatured by treatment at 96 degree for 10 mM, the mixture was cooled slowly at room temperature. Then, the mixture was mixed with 50 mg of the above immobilized beads, and was reacted for 1 hour with stirring in an incubator having a temperature of 20 degree. Immediately after the reaction, the beads and a supernatant were separated and collected by using a magnet. After washed twice with the buffer for nucleic acid separation, the beads were suspended in a fresh buffer for nucleic acid separation to react at 80 degree for 10 mM. Finally, a supernatant was immediately separated and collected from the beads by using a magnet.

### Example 6

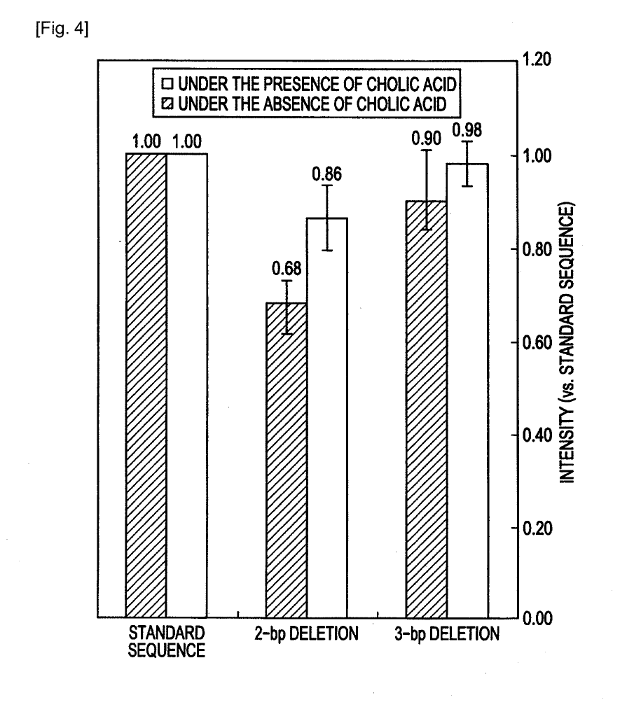

The DNA samples collected in Examples 4 and 5 were purified by Promega Wizard SV Gel and PCR Clean-up system (according to the protocol), and were amplified under the PCR condition of Example 2 except that the number of cycles was changed to 30 times. Then, the amplification bands were examined by electrophoresis and EtBr staining. The intensity of the band was calculated by ImageJ (open-source image-processing software developed in NIH). The intensity of the amplification band of the standard aptamer sequence for cholic acid was set to 1, and In respect to the supernatant samples after the reaction with corresponding immobilized beads, the respective deletion sequences (2 bp, 3 bp) were compared with the standard sequence to calculate the intensity of the bands of the deletion sequences (FIG. 4).

The results demonstrated that a decrease in the intensity was observed for the supernatant samples collected in Example 4 after the reaction of the various sequences with the biotinylated DNA-immobilized beads. In particular, the decrease was large for the 2-bp deletion sequence. A decrease in the intensity was also observed, in a similar manner, for the supernatant samples collected in Example 5 after the reaction of the various sequences with the biotinylated DNA-immobilized beads. However, the decrease in the intensity was found to be lower than that of Example 4. These results along with the relationship between the stem length and the stable structure as described in Table 1 demonstrated that the stem region-forming ability decreased depending on the length of the deletion set compared with that of the standard sequence under the absence of cholic acid (Example 4). As a result, the frequency to form an intermolecular duplex with a complementary strand on the beads increased. It is suggested that accordingly the concentration of the supernatant DNA decreased.

The concentration of the DNA in the supernatant (the intensity of the amplification band) was restored under the presence of cholic acid (Example 5). Thus, intramolecular duplex formation in the stem region was facilitated by the binding of cholic acid to the deletion set DNA, thereby decreasing the frequency to form the intermolecular duplex with a complementary strand on the beads. It is suggested that hence the concentration of the supernatant DNA increased. Further, in the deletion sets (2 bp, 3 bp), the intensity restoration under the presence of cholic acid was larger for the 2-bp deletion. In terms of the stable structure under the absence of cholic acid as illustrated in Table 1, the 2-bp deletion resulted in structures having a stem length of 0 bp (DG of the whole structure=−15.22 kcal/mol) and 6 bp (−15.03 kcal/mol), and the 3-bp deletion resulted in structures having a stem length of 6 bp (DG of the whole structure=−14.66 kcal/mol) and 7 bp (−14.87 kcal/mol). When this is taken into account, the 2-bp deletion allows the intramolecular stem region to be restored by the binding to cholic acid, so that the stable structure under the absence of cholic acid is considered to be largely shifted.

### Example 7

Next, designed were sequences (SEQ ID NOs: 10 and 11) of the library of candidate ligand of nucleic acids represented schematically in FIG. 1 and a control sequence (SEQ ID NO: 12), and they were synthesized as oligos. SEQ ID NO: 10 was constructed by randomizing only the second stem-loop region of the ch1-47 aptamer sequence for cholic acid (SEQ ID NO: 1) and by adding primer sequences for PCR at both the ends of the randomized sequence. SEQ ID NO: 11 was constructed by randomizing the first and second stem-loop regions of the ch1-47 aptamer sequence for cholic acid (SEQ ID NO: 1) and by adding primer sequences for PCR at both the ends of the randomized sequence. The control sequence was constructed by adding primer sequences for PCR at both the ends of the ch1-47 aptamer sequence for cholic acid. PCR primer sequences (SEQ ID NOs: 13 and 14) for a SELEX method were synthesized as oligos in a similar manner. SEQ ID NO: 13 was designed so as to amplify the actual aptamer sequence strand, and was biotinylated at the 5′ end.

SEQ ID NO 10:
5′-GTACCAGCTTATTCAATTTCGAGGGCAGCGATAGCTGNNNNNNNN
NNNNNNNNNCCATCGGAGATAGTATGTTCATCAG-3′
SEQ ID NO 11:
5′-GTACCAGCTTATTCAATTTCGAGGGNNNNNNNNNNNNNNNNNNNN
NNNNNNNNNCCATCGGAGATAGTATGTTCATCAG-3′
SEQ ID NO 12:
5′-GTACCAGCTTATTCAATTTCGAGGGCAGCGATAGCTGGGCTAATA
AGGTTAGCCCCATCGGAGATAGTATGTTCATCAG-3′
SEQ ID NO 13:
5′-gtaccagctt attcaattt-3′
SEQ ID NO 14:
5′-ctgatgaaca tactatctc-3′

### Example 8

A model target substance, cholic acid, was immobilized on a 96-well plate, which was manufactured by using the following procedure so as to carry out a SELEX method. First, to an aminated 96-well plate (Sumilon ELISA plate) manufactured by Sumitomo Bakelite Inc. were added 1 mM of a photocrosslinking group linker, NHS-LC-Diazirine (Succinimidyl 6-(4,4′-Azipentanamido)Hexanoate) manufactured by Thermo Scientific Inc. and 200 ml/well of PBS (Phosphate Buffered Saline) buffer. Then, an amino group was reacted with the NHS at room temperature under a dark condition for 1 hour while stirring. After the reaction, the reaction solution was discarded, and 200 ml of 100 mM Tris-HCl (pH8.0) was added. Next, the mixture was treated at room temperature for 5 min to inactivate an unreacted NHS.

Then, the solution was discarded, and the plate was washed well three times with PBS to add 200 ml of 0.5 mM cholic acid-containing solution (H₂O). After dried with a vacuum drier, the plate was placed directly under a 365-nm UV lamp (15 w×2) to carry out a crosslinking reaction for 15 mM. After that, the plate was washed well with PBS. Finally, the plate was rinsed with water and dried under a N₂ gas to preserve the plate with a shield in a desiccator until its use. This method allows cholic acid to be immobilized without an orientation, and a specific functional group is not required to be used in the immobilization. This procedure is very useful in performing a SELEX method for a small molecule in particular, and the carbene species of diazirine has a very potent reactivity and is suitable for the immobilization of a variety of low-molecular-weight compounds.

### Example 9

The libraries of candidate ligand of nucleic acid having a concentration of 100 nM as manufactured in Example 7 were prepared with a binding buffer (50 mM Tris-HCl (pH 7.6), 300 mM NaCl, 30 mM KCl, 5 mM MgCl₂, 0.01% Tween20, 0.1% PEG8000). The libraries of candidate ligand were denatured at 95 degree for 5 min, and were placed without stirring for 30 mM at room temperature. The biotinylated DNA (SEQ ID NO: 8)-immobilized beads were manufactured according to Example 3. Next, the above library of candidate ligand of nucleic acids was reacted with the immobilized beads according to Example 4. The buffer for nucleic acid separation of the foregoing Example 4 was changed to the binding buffer in this Example. The reaction temperature was changed to 25 degree. A fraction (a library of candidate ligand of nucleic acids) which bound to the beads to be obtained in this step was used in the following Example. If needed, this step may repeat several times.

### Example 10

The libraries of candidate ligand collected in Example 9 were denatured at 95 degree for 5 min, and were placed without stirring for 30 mM at room temperature. Next, 100 ml of the library of candidate ligand was added to the cholic acid-immobilized plate prepared in Example 8, and was reacted at 25 degree for 1 hour while stirring. Then, the plate was washed well with a binding buffer, and 100 ml of 5 mM cholic acid-containing solution (a binding buffer) was added to treat the plate for 30 mM while stirring. Further, the plate was treated at 95 degree for 5 mM, and then the library of candidate ligand of nucleic acids binding to the immobilized cholic acid was eluted. The mixture eluted was purified by Promega Wizard SV Gel and PCR Clean-up system (according to the protocol), and was dissolved in 50 ml of sterile water. After that, a PCR was conducted by using the PCR primer sequences (SEQ ID NOs: 13 and 14) for a SELEX method.

TAKARA LA Taq was used (the reaction solution is in according to the protocol), and for the reaction condition, 30 times of the cycle of denaturation at 94 degree for 30 sec, annealing at 48 degree for 30 sec, and elongation at 72 degree for 15 sec) were carried out. At the last, a cycle (at 72 degree for 1 mM) was performed. The amplified DNA was purified by Wizard SV Gel and PCR Clean-up system (according to the protocol), and only the biotinylated library of candidate ligand of nucleic acids was collected by using streptavidin-immobilized beads manufactured by Bangs Laboratories, Inc. (according to the protocol). This step was defined as one cycle, and repeated 10 cycles.

### Example 11

The library of candidate ligand of nucleic acids collected in Example 10 was treated using the biotinylated DNA (SEQ ID NO: 8)-immobilized beads manufactured in Example 3 in a manner according to Example 5. In the step of Example 5, the buffer for nucleic acid separation was changed to the binding buffer, and the temperature was changed from 20 degree to 25 degree. A supernatant fraction of this step was collected. This step may repeat several times. Next, the buffer replacement and purification were performed by Wizard SV Gel and PCR Clean-up system (Promega Inc.) (according to the protocol), and a PCR was carried out under the PCR condition for a SELEX method by using primer sequences without biotinylation. After that, the amplified DNA was cloned, and the nucleotide sequences of clones picked randomly were determined. A population of the DNA sequences of aptamers binding to cholic acid as enriched by a SELEX method was obtained.

### Example 12

The PCR primer sequences for a SELEX method were removed from the DNA sequence of the resulting aptamer binding to cholic acid. The resulting sequence was synthesized as an oligo, and its property of binding to cholic acid was evaluated by using SPR and ITC, etc.

### Example 13

PCR primer sequences for a SELEX method were removed from the DNA sequence of the resulting aptamer binding to cholic acid. The sequence in which fluorescent FAM (excitation 495 nm, emission 520 nm) and fluorescent ROX (excitation 590 nm, emission 610 nm) were linked to both the ends of the resulting sequence was synthesized as an oligo. FRET (Fluorescence Resonance Energy Transfer) before and after addition of cholic acid was determined with a fluorescence spectrophotometer. At the time of excitation of FAM, the phenomenon that a fluorescent intensity of ROX increased under the presence of cholic acid was verified.

### Example 14

Obtained was a CD spectrum of the DNA sequence of the aptamer binding to cholic acid in the presence or absence of cholic acid. Then, a change in the CD spectrum upon a duplex formed under the presence of cholic acid was determined.

### Example 15

A population of the DNA sequences of the aptamer binding to cholic acid was compared with which was obtained by a SELEX method without performing the separation step using the biotinylated DNA (SEQ ID NO: 8)-immobilized beads. The aptamers binding to cholic acid which were derived from the population of sequences obtained according to a method of the present invention were verified to have an increased efficiency in FRET and a large CD spectrum change. This means that the present invention imparts the capacity for structural change forming an intramolecular duplex between pre-engineered stem regions upon binding to a target substance, and also means that the aptamer molecule having a binding affinity for cholic acid can be efficiently obtained by a method for screening of the present invention. In addition, the resulting aptamer molecule of the present invention should have an effect as a capture molecule for fluorescent sensing in particular.

From the preceding Examples, the sequences of the nucleic acid ligands forming a specific secondary structure according to the present invention were identified.

### INDUSTRIAL APPLICABILITY

The nucleic acid ligands identified by the present method for screening enable an intramolecular duplex to be formed between pre-engineered conserved domains upon an interaction with a target substance. They can be used as biosensors, molecular switches and signal transduction molecules, which utilize this structural change in particular. For example, introduction of a fluorescent reporter molecule into a specific site of the intramolecular duplex formed by binding to the target substance enables a stable signal to be achieved. In addition, the complex should be stabilized because the intramolecular duplex is formed after binding to the target substance, so that the nucleic acid ligand having a higher binding affinity can be achieved. In addition, the site for introducing the fluorescent reporter molecule can be further precisely designed in terms of the introduction by carrying out a structural analysis of a complex of a target substance with the nucleic acid ligand obtained according to the present method. Furthermore, according to a method of the present invention, the conserved sequence can be similarly utilized even if the target substance varies. Thus, the method is a systematic method for obtaining the nucleic acid ligand. The method has prominent advantages in the case of handling multiple materials such as in the case of allowing a sensor to be arrayed and to detect a plurality of different kinds in a bulk system. In addition, in the method for screening of the present invention, a nucleic acid ligand is obtained by utilizing, as an index, both the binding affinity for a target substance and the capacity for structural change, and therefore, a concern can be resolved that the binding affinity for a target substance is lost due to reengineering so as to impart the capacity for structural change to the ligand.

This application claims the benefit of Japanese Patent Applications No. 2010-043559, filed Feb. 26, 2010, and No. 2011-018651, filed Jan. 31, 2011, which are hereby incorporated by reference herein in their entirety.

1. A method for screening a library of candidate of nucleic acid ligands for a nucleic acid ligand forming a specific secondary structure upon binding to a target substance, the method comprising:
(a) preparing a library of candidate of nucleic acid ligands including a random sequence domain to bind a target substance and a conserved sequence domain to form a specific secondary structure;
(b) contacting, under the absence of the target substance, the library with a supporting member in which a complementary sequence domain complementarily binding to at least one of the conserved sequence domains included in the nucleic acid ligand is disposed on a surface of the supporting member, and then separating and removing a nucleic acid ligand which does not form an intermolecular duplex by utilizing a phenomenon that the intermolecular duplex is formed between a nucleic acid ligand and the complementary sequence domain on the surface of the supporting member; and
(c) dissociating the intermolecular duplex by contacting, under the presence of the target substance, the target substance with the remaining nucleic acid ligand forming the intermolecular duplex obtained in (b), and then separating and collecting a nucleic acid ligand having the specific secondary structure formed by the binding to the target substance,
wherein the method includes at least one time of (b) and at least one time of (c).

2. The method for screening according to claim 1, wherein (c) comprises:
collecting a remaining nucleic acid ligand forming the intermolecular duplex obtained in (b), mixing the nucleic acid ligand with the target substance, and contacting the mixture with the supporting member, and then separating and collecting a nucleic acid ligand having a specific secondary structure formed upon binding to the target substance by utilizing a phenomenon that the intermolecular duplex is not formed.

3. The method for screening according to claim 1, further comprising, after (c), (d) removing the target substance from the collected nucleic acid ligand forming the specific secondary structure.

4. The method for screening according to claim 1, further comprising, before (b):
contacting the library with the target substance so that a nucleic acid ligand having a higher affinity for the target substance forms a nucleic acid ligand-target substance complex;
removing a nucleic acid ligand which does not form the complex;
separating and collecting only a nucleic acid ligand having the higher affinity from the complex; and
amplifying the nucleic acid ligand having the higher affinity to produce a library of candidate of the enriched nucleic acid ligands.

5. The method for screening according to claim 3, further comprising, after (d):
contacting the target substance with a nucleic acid ligand forming a specific secondary structure from which the target substance is removed, the nucleic acid ligand obtained in (c) so that a nucleic acid ligand having a higher affinity for the target substance forms a nucleic acid ligand-target substance complex;
removing a nucleic acid ligand which does not form the complex;
separating and collecting only a nucleic acid ligand having the higher affinity from the complex; and
amplifying the nucleic acid ligand to enrich the nucleic acid ligand having the higher affinity.

6. A method for screening a library of candidate of nucleic acid ligands for a nucleic acid ligand forming a specific secondary structure upon binding to a target substance, the method comprising:
(a′) preparing a library of candidate of nucleic acid ligands including a random sequence domain to bind a target substance and a conserved sequence domain to form a specific secondary structure;
(b′) contacting, under the presence of the target substance, the library with a supporting member in which a complementary sequence domain complementarily binding to at least one of the conserved sequence domains included in the nucleic acid ligand is disposed on a surface of the supporting member, and then separating and collecting a nucleic acid ligand which does not form an intermolecular duplex by utilizing a phenomenon that the intermolecular duplex is formed between a nucleic acid ligand and the complementary sequence domain on the surface of the supporting member;
(c′) removing the target substance from the nucleic acid ligand separated and collected in (b′); and
(d′) contacting, under the absence of the target substance, the supporting member with a nucleic acid ligand obtained in (c′) from which the target substance is removed, and then separating and collecting a nucleic acid ligand forming the intermolecular duplex between the nucleic acid ligand and the complementary sequence domain on the surface of the supporting member.

7. A method for identifying a sequence of a nucleic acid ligand forming a specific secondary structure, wherein the ligand is obtained according to claim 1.
